(19) United States
(12) Patent Application Publication
(10) Pub. No.: US 2025/0332986 A1
(43) Pub. Date: Oct. 30, 2025

(54) METHODS AND APPARATUS TO DETERMINE A LOAD PITCH ANGLE OF A VEHICLE FOR HEADLAMP ADJUSTMENT

(71) Applicant: Ford Global Technologies, LLC, Dearborn, MI (US)

(72) Inventors: Jannis Koenkes, Bonn (DE); Matthias Reiter, Aachen (DE); Lars Lottner, Odenthal (DE)

(21) Appl. No.: 19/190,235

(22) Filed: Apr. 25, 2025

(30) Foreign Application Priority Data
Apr. 29, 2024 (DE) 102024111965.9

(51) Int. Cl. B60Q 1/115; G01C 9/00

(52) U.S. Cl. CPC B60Q 1/115; G01C 9/00

(57) ABSTRACT

Methods and apparatus to determine a load pitch angle of a vehicle for headlamp adjustment are disclosed. An example method for determining a load pitch angle of a vehicle for adjustment of a headlamp of the vehicle includes determining the speed of the vehicle based on first output from a first sensor during a time interval, determining the acceleration of the vehicle based on second output from a second sensor during the time interval, determining the height change of the vehicle based on third output from a third sensor during the time interval, determining the load pitch angle based on the speed, the acceleration and the height change corresponding to the time interval, and controlling the adjustment of the headlamp based on the determined load pitch angle.

### RELATED APPLICATION

This patent claims priority from DE Patent Application Number 10 2024 111 965.9, which was filed on Apr. 29, 2024, and is hereby incorporated herein by reference in its entirety.

### FIELD OF THE DISCLOSURE

The disclosure relates to a method for determining the current load pitch angle of a vehicle for automatic headlamp beam adjustment of at least one headlamp of the vehicle. The disclosure also relates to methods and apparatus for adjusting the beam of at least one headlamp, a vehicle.

### BACKGROUND

The term “pitch angle” refers to the instantaneous angle of the vehicle above the ground. This varies rapidly and is influenced both by the loading of the vehicle, the vehicle longitudinal dynamics, in particular braking, acceleration, as well as uphill and downhill due to additional power demand, and by random road unevenness. As used herein, the factory state or calibration state of an unladen vehicle is defined as a state with a pitch angle of zero degrees. All other angles describe a deviation from the factory state or from the unladen state.

### SUMMARY

An example method for determining a load pitch angle of a vehicle for adjustment of a headlamp includes determining the speed of the vehicle based on first output from a first sensor during a time interval, determining the acceleration of the vehicle based on second output from a second sensor during the time interval, determining the height change of the vehicle based on third output from a third sensor during the time interval, determining the load pitch angle based on the speed, the acceleration and the height change corresponding to the time interval, and controlling the adjustment of the headlamp based on the determined load pitch angle.

An example apparatus to control beam adjustment for a headlamp of a vehicle includes a first sensor for determining a speed of the vehicle, a second sensor for determining an acceleration of the vehicle, a third sensor for determining a height change of the vehicle, machine readable instructions, and programmable circuitry to determine a load pitch angle based on the speed, the acceleration and the height change, and cause adjustment of the headlamp based on the determined load pitch angle.

An example non-transitory machine readable storage medium includes instructions to cause programmable circuitry to at least determine a speed of a vehicle during a time interval, determine an acceleration of the vehicle during the time interval, determine a height change of the vehicle during the time interval, determine a load pitch angle of the vehicle based on the speed, the acceleration and the height change, and control an adjustment of a headlamp of the vehicle based on the determined load pitch angle.

### BRIEF DESCRIPTION OF THE DRAWINGS

FIG. 1 illustrates a schematic diagram of a method according to examples disclosed herein for determining the current load pitch angle of a vehicle in the form of a flowchart.

FIG. 2 illustrates an example geometrical relationship between the distance traveled ds, the height difference Δh, the projection sₚᵣₒⱼ of ds on the horizontal plane and the angle of inclination of the road surface θ_{road}.

FIG. 3 illustrates an example schematic diagram of a model for determining the mean dynamic pitch angle in the form of a flowchart.

FIG. 4 illustrates a schematic drawing of a method according to examples disclosed herein for beam height adjustment in the form of a flowchart.

FIG. 5 illustrates a schematic diagram of a motor vehicle according to examples disclosed herein with a device according to examples disclosed herein for beam height adjustment.

FIG. 6 is a block diagram of an example programmable circuitry platform structured to execute and/or instantiate the example machine-readable instructions and/or the example operations of FIGS. 1 and 4 to implement examples disclosed herein.

In general, the same reference numbers will be used throughout the drawing(s) and accompanying written description to refer to the same or like parts. The figures are not necessarily to scale.

### DETAILED DESCRIPTION

As used herein, an averaged pitch angle refers to a measuring angle of a system for determining an averaged pitch angle when a vehicle is driving (e.g. via a camera that determines a horizon angle based on a series of images). The load pitch angle is a quasi-static component of the pitch angle, which depends on the loading, but not on the driving situation. The load pitch angle corresponds to the angle that is set when the vehicle is at a standstill on a horizontal surface. A dynamic pitch angle refers to the current (e.g., the instantaneous, rapidly varying, etc.) deviation of the pitch angle from the load pitch angle, in other words the portion of the pitch angle that depends on the driving situation (e.g., braking, accelerating, uphill, downhill).

According to examples disclosed herein, to determine the dynamic pitch angle, the longitudinal acceleration of the vehicle can be measured, which usually correlates very well with the dynamic pitch angle, since the dynamic pitch angle is mainly caused by acceleration forces that act on a predominantly linearly spring-mounted system.

Automatic headlamp beam height adjustment systems can necessitate the current load pitch angle (e.g., a neutral pitch angle) of the vehicle with respect to the road surface as an input variable. A change in the pitch angle can occur in particular as a result of the driving style or as a result of loading or unloading the vehicle, for example, a car with a loaded trunk. When the load pitch angle changes, the headlamps should be readjusted (e.g., corrected upwards or downwards with respect to their beam angle). For motor vehicles registered in the European Union (EU), automatic beam height adjustment systems are mandatory for certain types of headlamps.

Currently, the pitch angle of a vehicle is typically determined using two mechanical level sensors, with a first level sensor being mounted on the front axle and a second level sensor mounted on the rear axle. The level sensors provide information about a change in the suspension height, wherein an electrical output signal from the level sensor changes depending on the suspension height of the vehicle. This signal can be utilized by a control unit (e.g., a headlamp control module (HCM)) to calculate the pitch angle and to control a stepper motor within the headlamp for its adjustment. In combination with knowledge of the wheelbase, a method for determining the change in the pitch angle of a vehicle, for example, due to additional loading or other factors, is thus available. There are also other variants available that are based on only one level sensor, typically on the rear axle.

However, these sensors are complex to integrate into existing vehicles. They are also maintenance-intensive, as they are exposed to environmental effects such as the weather, and mechanical effects caused by the road surface, in particular possible stone chips. It can therefore be desirable to replace the previously described solution based on mechanical sensors by suitable alternatives. A combination of other existing sensors proves particularly useful. While it is actually possible to determine the load pitch angle using other sensors, typically ones already present in a vehicle, such as acceleration sensors, it is difficult to achieve the required accuracy, however, which allows only small tolerances for lighting requirements.

Known methods are capable of determining an average pitch angle with respect to the road surface via images acquired by a front-facing camera. The average pitch angle is typically determined while the vehicle is driving. Since the vehicle pitch angle can vary depending on driving conditions, for example, the vehicle pitch angle may change in connection with an ascent or descent, the average pitch angle determined by the camera also differs from the pitch angle of the vehicle that occurs when the vehicle comes to a standstill in a horizontal plane (e.g., a load pitch angle). However, a headlamp beam height adjustment system can necessitate this load pitch angle as an input variable. It is possible, however, to compensate for the influence of driving conditions using known methods. Camera systems also represent an additional hardware component and require appropriate environmental conditions, such as clear vision, for optimum reliability, so that an alternative method of determining an averaged pitch angle with respect to the road surface is desirable.

Known documents include DE 10 2017 005 019 A1, DE 10 2020 128 440 A1, DE 10 2011 017 697 A1, US 2021/0323466 A1 and US 2017/0225609 A1 describe methods and devices for adjusting the headlamp beam height using a camera. In document U.S. Pat. No. 10,953,787 B2, various sensors are used in connection with headlamp beam height adjustment. Further prior art is disclosed in documents EP 2 130 718 A2, CN 112477750 B, DE 10 2021 006290 A1, EP 0 709 240 A1, U.S. Pat. No. 6,693,380 B2, U.S. Pat. No. 6,450,673 B1, U.S. Pat. No. 6,193,398 B1, U.S. Pat. No. 9,260,051 B2, 5 US 2016/0 288 698 A1, JP 5597472 B2, U.S. Pat. No. 10,676,016 B2, U.S. Pat. No. 11,390,207 B2, DE 10 2019 000 942 A1, US 2022 0 212 600 A1, US 2023 0 182 637 A1 and U.S. Pat. No. 9,908,458 B2.

Against this background, an object of examples disclosed herein is to provide an advantageous method for determining the current load pitch angle of a vehicle for automatic headlamp beam height adjustment. Other objects include providing an advantageous method for headlamp beam height adjustment, an advantageous device for headlamp beam height adjustment, a vehicle, a computer-implemented method, a computer program product, a computer-readable data carrier, and a data carrier signal.

These objects are achieved by a method for determining the current load pitch angle of a vehicle, a method for headlamp beam height adjustment, a device for headlamp beam height adjustment, a vehicle, a computer-implemented method, a computer program product, a computer-readable data carrier, and a data carrier signal.

A method according to examples disclosed herein for determining, in particular estimating, the current load pitch angle of a vehicle for automatic beam height adjustment of at least one headlamp, for example a front headlamp, of the vehicle relates to a vehicle which comprises at least one means (e.g., a sensor) for determining the speed of the vehicle in the longitudinal direction, at least one means (e.g., a sensor) for determining the longitudinal acceleration of the vehicle and at least one means (e.g., a sensor) for determining a change in the height (e.g., the altitude) of the vehicle.

A method according to examples disclosed herein comprises the following operations. In a first operation, the speed, in particular the current speed, of the vehicle in the longitudinal direction is determined (e.g., detected or measured) and tracked using the device for determining the speed (e.g., means for determining the speed) of the vehicle. In a second operation, the longitudinal acceleration, in particular the current acceleration, of the vehicle is determined (e.g., detected or measured) and tracked using the device for determining the longitudinal acceleration (e.g., means for determining the longitudinal acceleration) of the vehicle. In a third operation, the change in the height of the vehicle is determined (e.g., detected or measured) and tracked using a device for determining the change in height (e.g., means for determining the change in height) of the vehicle. The example three operations mentioned above can be carried out simultaneously while the vehicle is driving.

In a fourth operation, while the vehicle is driving the current load pitch angle is determined (e.g., estimated or calculated). The determination can be based on the speed of the vehicle in the longitudinal direction, longitudinal acceleration of the vehicle and height change (e.g., an altitude change) of the vehicle, determined in a defined time interval or time window (e.g., in a definable or specified or specifiable time interval). Thus, the longitudinal speed, the longitudinal acceleration and the height change of the vehicle are measured within a common time interval or time window, for example.

It is known that acceleration sensors can measure the inclination or tilt of an object (e.g., the pitch angle of a vehicle) by measuring the gravitational component and expressing it as a ratio of the gravitational constant. However, in dynamic systems such as a moving vehicle, interference factors occur that affect the measurement. For example, if the vehicle speed changes, the measured acceleration also includes the acceleration in relation to the road surface. In addition, a measurement of the pitch angle using an acceleration sensor is influenced by the gradient of the road surface and by dynamic pitch behavior (e.g., due to road unevenness or acceleration of the vehicle). The influence of a longitudinal acceleration of the vehicle is compensated in the context of examples disclosed herein by taking into account the detected vehicle speed. The influence of a gradient of the road surface is compensated in the context of examples disclosed herein by taking into account the detected change in height. The influence of the dynamic pitch behavior of the vehicle can be estimated and compensated based on the detected speed and acceleration by a model (e.g., a model representing the dynamic pitch behavior of the vehicle, such as a dynamic pitch model).

A method according to examples disclosed herein has the advantage that a load pitch angle can be determined without the use of a camera or the level sensors described earlier. Thus, in connection with a headlamp beam height adjustment, the use of level sensors and/or a camera system may be omitted in the future. In addition, the reliability of the determination of the load pitch angle and thus the headlamp beam height adjustment is enhanced, since no moving components are required for determining the pitch angle. By eliminating the need for a camera system to determine the current load pitch angle, the reliability of the determination under environmental or weather conditions unfavorable for a camera system can be enhanced.

In an advantageous example, the determination (e.g., the estimation or calculation) of the current load pitch angle based on the measured speed in the longitudinal direction of the vehicle, the measured longitudinal acceleration of the vehicle, the measured height change of the vehicle and the dynamic pitch angle of the vehicle is carried out with a dynamic pitch model (e.g., a model that describes the dynamic pitching behavior of a vehicle). The speed, acceleration and height change can be determined in a specified or specifiable or a defined or definable time interval or time window. The use of a dynamic pitch model allows the dynamic pitch angle to be compensated and, thus, the current load pitch angle to be determined. A known system for a dynamic pitch model is described in EP 0 709 240 B1, for example.

A GNSS (Global Navigation Satellite System) sensor, such as a GPS sensor or comparable sensor, for example, can be used as the device for determining the change in height (e.g., the means for determining the change in height). It is also possible to determine the height change of the vehicle based on the ambient air pressure or by using a map-based determination of the height change of the vehicle. An acceleration sensor can be used as the device for determining the longitudinal acceleration (e.g., the means for determining the longitudinal acceleration) of the vehicle. A speed sensor can be used as the device for determining the speed (e.g., the means for determining the speed) in the longitudinal direction of the vehicle. The use of these sensors, which are normally already present in a vehicle, can be advantageous. Consequently, vehicles can be retrofitted easily.

In another variant, the length of a path traveled by the vehicle during a certain time interval or integration interval can be determined and/or a height difference covered by the vehicle during a certain time interval or integration interval can be determined, and the current load pitch angle can be determined based on the determined length of the path and/or the determined height difference.

In addition, a mean dynamic pitch angle can be determined during a specific time interval or integration interval and the current load pitch angle can be determined based on the determined mean dynamic pitch angle. The mean dynamic pitch angle can be determined based on a model. The model can comprise lookup tables. The model and/or the lookup tables may be tailored to a specific vehicle or vehicle model (e.g., a specific vehicle type).

According to examples disclosed herein, from the lookup tables, a first lookup table can be implemented to determine an acceleration-based value of the dynamic pitch angle as a function of the measured acceleration (e.g., the current acceleration) of the vehicle and of a selected load pitch angle, and a second lookup table can be implemented to determine a speed-based value of the dynamic pitch angle as a function of the measured speed (e.g., the current speed) of the vehicle and of a selected load pitch angle. Acceleration and speed have been identified as the two dominant influencing factors, and other influencing factors can also be taken into account, such as an attached trailer. The selected load pitch angle can be a load pitch angle selected from a plurality of required or assumed load pitch angles, which was defined in advance for a specific loading situation. The mean dynamic pitch angle can be determined by averaging from an acceleration-based value of the dynamic pitch angle determined via the first lookup table and a speed-based value of the dynamic pitch angle determined via the second lookup table.

In one example, the current load pitch angle θₙₑᵤₜᵣₐₗ is determined using the example calculation below:

$${Θ}_{neutral} \approx \frac{\int {α}_{m e a s} ds - \frac{1}{2} \cdot ( {v}_{2}^{2} - {v}_{1}^{2} ) - g * Δ h + g \cdot {\overline{Θ}}_{dynamic} \cdot \sqrt{{s}^{2} - Δ {h}^{2}}}{- g \cdot \sqrt{{s}^{2} - Δ {h}^{2}} - g \cdot {\overline{Θ}}_{dynamic} * Δ h} ,$$

where s is the distance traveled by the vehicle in an integration interval under consideration, v₁ is the speed of the vehicle at the beginning of the integration interval, v₂ is the speed of the vehicle at the end of the integration interval, Δh is the height difference covered by the vehicle during the integration interval, aₘₑₐₛ is the measured longitudinal acceleration of the vehicle, g is the gravitational constant and θ̅_{dynamic} is the mean (e.g., averaged) dynamic pitch angle of the vehicle during the integration interval. The derivation of the formula is outlined below.

The measured longitudinal acceleration aₘₑₐₛ results from the acceleration over the ground a_{gnd} and the gravitational component of the acceleration caused by the pitch angle θ of the vehicle.

$${α}_{meas} = {α}_{gnd} - g \cdot sin ( Θ )$$

The pitch angle θ of the vehicle can be decomposed into the angle of inclination of the road θ_{road}, the load pitch angle of the vehicle θₙₑᵤₜᵣₐₗ and the dynamic pitch angle of the vehicle θ_{dynamic}.

$$Θ = {Θ}_{road} + {Θ}_{neutral} + {Θ}_{dynamic}$$

Using the trigonometric relationship:

$$sin ( α + β + γ ) = sin ( α ) \cdot cos ( β ) \cdot cos ( γ ) + cos ( α ) \cdot sin ( β ) \cdot cos ( γ ) + cos ( α ) \cdot cos ( β ) \cdot sin ( γ ) - sin ( α ) \cdot sin ( β ) \cdot sin ( γ )$$

Accordingly, the following applies:

$${α}_{meas} = {α}_{gnd} - g \cdot ( sin ( {Θ}_{road} ) \cdot cos ( {Θ}_{neutral} ) \cdot cos ( {θ}_{dynamic} ) + cos ( {Θ}_{road} ) \cdot sin ( {Θ}_{neutral} ) \cdot cos ( {Θ}_{dynamic} ) + cos ( {Θ}_{road} ) \cdot cos ( {Θ}_{neutral} ) \cdot sin ( {Θ}_{dynamic} ) - sin ( {Θ}_{road} ) \cdot sin ( {Θ}_{neutral} ) \cdot sin ( {Θ}_{dynamic} ) )$$

Applying the approximation for small angles (Sin(θₙₑᵤₜᵣₐₗ)=9 neutral; sin(θ_{dynamic})=θ_{dynamic}, cos(θₙₑᵤₜᵣₐₗ)=1, cos(θ_{dynamic})=1):

$${α}_{meas} = {α}_{gnd} - g * ( sin ( {Θ}_{road} ) + {Θ}_{neutral} * cos ( {Θ}_{road} ) + {Θ}_{dynamic} * cos ( {Θ}_{road} ) - {Θ}_{neutral} * {Θ}_{dynamic} * sin ( {Θ}_{road} ) )$$

Integration over the path s yields:

$$\int {a}_{meas} ds = \int {a}_{gnd} ds - g \cdot ( sin ( {Θ}_{road} ) + {Θ}_{neutral} \cdot cos ( {Θ}_{road} ) + {Θ}_{dynamic} \cdot cos ( {Θ}_{road} ) - {Θ}_{neutral} \cdot {Θ}_{dynamic} \cdot sin ( {Θ}_{road} ) ) ds .$$

Assuming that the gravitational constant g and the load pitch angle θₙₑᵤₜᵣₐₗ are constant, this can be rearranged as follows:

$$\int {a}_{meas} ds = \int {a}_{gnd} ds - g \cdot \int sin ( {Θ}_{road} ) ds - g \cdot {Θ}_{neutral} \cdot \int cos ( {Θ}_{road} ) ds - g \cdot \int {Θ}_{dynamic} \cdot cos ( Θ\_ \{ {Θ}_{road} ) ds + g \cdot {Θ}_{neutral} \cdot \int {Θ}_{dynamic} \cdot sin ( {Θ}_{road} ) ds .$$

Solving the equation for θₙₑᵤₜᵣₐₗ results in:

$${Θ}_{neutral} = \frac{\begin{matrix}\int {a}_{meas} ds - \int {a}_{gnd} ds + g \cdot \int sin ( {Θ}_{road} ) ds + \\ g \cdot \int {Θ}_{dynamic} \cdot cos ( {Θ}_{road} ) ds\end{matrix}}{- g \cdot \int cos ( {Θ}_{road} ) ds + g \cdot \int {Θ}_{dynamic} \cdot sin ( {Θ}_{road} ) ds}$$

Using an auxiliary analysis based on Newton's second law F=m×a and assuming that the mass of the vehicle remains constant, this can be simplified as follows:

$$\int {a}_{gnd} ds = \frac{1}{m} \cdot \int F ds .$$

The integral F ds is identical to the mechanical work W required to accelerate the vehicle, which in turn corresponds to the change in kinetic energy ΔEₖᵢₙ.

$$\int F ds = W$$

$$\int F ds = Δ {E}_{kin}$$

$$\int F ds = \frac{1}{2} \cdot m \cdot {v}_{2}^{2} - \frac{1}{2} \cdot m \cdot {v}_{1}^{2}$$

$$\int F ds = \frac{1}{2} \cdot m \cdot ( {v}_{2}^{2} - {v}_{1}^{2} )$$

From this it follows that:

$$\int {a}_{gnd} ds = \frac{1}{2} \cdot ( {v}_{2}^{2} - {v}_{1}^{2} ) .$$

The integral ds corresponds to the distance s traveled by the vehicle during the integration. Multiplication by sin(θ_{road}) results in the difference in height Δh covered during the integration (see FIG. 2). This allows the following simplification:

$$g \cdot \int sin ( {Θ}_{road} ) ds = - g \cdot Δ h .$$

The integral ds over cos(θ_{road}) corresponds to the projection sₚᵣₒⱼ of ds onto the horizontal (see FIG. 2). Using the Pythagorean theorem, sₚᵣₒⱼ can be calculated:

$${s}_{proj} = \sqrt{{s}^{2} - Δ {h}^{2}} .$$

Now this can be simplified to:

$$g \cdot \int cos ( {Θ}_{road} ) ds \approx g \cdot \sqrt{{s}^{2} - Δ {h}^{2}}$$

Similarly, this can be simplified:

$$g \cdot \int {Θ}_{road} \cdot cos ( {Θ}_{road} ) ds \approx g \cdot {\overline{Θ}}_{road} \cdot \sqrt{{s}^{2} - Δ {h}^{2}} .$$

Similarly, this can also be simplified:

$$g \cdot \int {Θ}_{dynamic} \cdot sin ( {Θ}_{road} ) ds \approx - g \cdot {\overline{Θ}}_{dynamic} \cdot Δ h .$$

As a result, from the assumptions and simplifications described it follows that:

$${Θ}_{neutral} \approx \frac{\int {a}_{meas} ds - \frac{1}{2} \cdot ( {v}_{2}^{2} - {v}_{1}^{2} ) - g \cdot Δ h + g \cdot {\overline{Θ}}_{dynamic} \cdot \sqrt{{s}^{2} - Δ {h}^{2}}}{- g \cdot \sqrt{{s}^{2} - Δ {h}^{2}} - g \cdot {\overline{Θ}}_{dynamic} \cdot Δ h}$$

Simulations, vehicle tests and reference measurements have shown that a reliable determination of the current load pitch angle is enabled based on the disclosed method according to examples disclosed herein when using suitable sensors.

The method according to examples disclosed herein for adjusting the beam height of at least one headlamp, for example a front headlamp, of a vehicle comprises the following operations. First, a setting position of the at least one headlamp is determined. The prerequisite for this is an adjustment of the zero angle. Thus, with a nominal basic setting of a stepper motor angle, the headlamp is calibrated as part of the assembly in such a way that a defined light exit gradient is achieved. Normally, the headlamp is set (by activation) to a “zero position” at the end of the production line. Since the headlamps as a component are subject to large mechanical tolerances, the angle is then corrected by adjusting screws (or electronic activation) so that the light is emitted at a fixed angle. This process is also known as “adjustment” or “aiming” and provides the setting position as a prerequisite for any further compensation. Subsequent beam height adjustment or “leveling” identifies changes in the angle between the vehicle and the ground and compensates for the fixed light exit angle or the required deviation from the setting position.

Subsequent to the determination of the setting position of the at least one headlamp, the current load pitch angle of the vehicle is determined by a method according to examples disclosed herein described above. In a next operation, the deviation of the current load pitch angle of the vehicle from the setting position and, thus, the resulting deviation of the at least one headlamp from the setting position is determined. In particular, a new setpoint angle can be defined. The setting, in particular the light exit angle, of the at least one headlamp is then adjusted according to the determined deviation. In particular, the new, defined setpoint angle can be activated. The beam height can be adjusted by mechanically rotating a pivot frame by the required angle (e.g., controlled by a stepper motor). With high-resolution pixel headlights, it can be possible to switch pixel rows on or off so that no light is emitted above the desired light-dark limit. In other words, a change in the light exit angle can be compensated.

A method according to examples disclosed herein for beam height adjustment has the features and advantages described in connection with the method according to examples disclosed herein for determining the current load pitch angle of the vehicle.

A device according to examples disclosed herein for beam height adjustment of at least one headlamp of a vehicle relates to a vehicle or a device for beam height adjustment, which comprises at least one device for determining the speed (e.g., means for determining the speed) of the vehicle in the longitudinal direction, at least one device for determining the longitudinal acceleration (e.g., means for determining the longitudinal acceleration) of the vehicle and at least one device for determining the height change of the vehicle (e.g., means for determining the height change of the vehicle). The device for determining the change in height may comprise a GNSS sensor. The device for determining the longitudinal acceleration of the vehicle may comprise an acceleration sensor. The device for determining the speed in the longitudinal direction of the vehicle may comprise a speed sensor.

A device according to examples disclosed herein for beam height adjustment is configured to receive data from the device for determining the speed of the vehicle in the longitudinal direction, the device for determining the longitudinal acceleration of the vehicle and the device for determining the height change of the vehicle and to carry out a method for beam height adjustment according to examples disclosed herein described above. The device according to examples disclosed herein for beam height adjustment has the features and advantages already mentioned in connection with the method according to examples disclosed herein.

A vehicle according to examples disclosed herein includes a device for beam height adjustment described above. The vehicle has the advantages already described. The vehicle can be an electric vehicle or a vehicle having an internal combustion engine or a hybrid electric vehicle (HEV). The vehicle can be a motor vehicle (e.g., a passenger car, a truck, a bus, a minibus, a motorcycle or a moped, etc.).

A computer-implemented method according to examples disclosed herein includes commands, which during the execution of the program by a computer cause said computer to carry out an example method. The computer program product according to examples disclosed herein includes commands, which during the execution of the program by a computer cause said computer to carry out a method according to examples disclosed herein described above. The computer program product according to examples disclosed herein is stored on the computer-readable data carrier according to examples disclosed herein. The data carrier signal according to examples disclosed herein transmits the computer program product according to examples disclosed herein. The computer-implemented method according to examples disclosed herein, the computer program product according to examples disclosed herein, the computer-readable data carrier according to examples disclosed herein, and the data carrier signal according to examples disclosed herein have the above-mentioned features and advantages.

Examples disclosed herein are described hereafter in greater detail on the basis of examples and by reference to the attached drawings. Although examples disclosed herein are illustrated and described in greater detail by the preferred examples, examples disclosed herein are not restricted by the examples disclosed and other variations can be derived therefrom by the person skilled in the art without departing from the scope of protection of examples disclosed herein.

The figures are not necessarily accurate in every detail or true to scale and can be shown enlarged or reduced in order to provide a better overview. Therefore, functional details disclosed here are not to be understood in a restrictive sense, but merely as a descriptive basis which offers guidance to the person skilled in the art in this field of technology for applying examples disclosed herein in a variety of ways.

As used herein, the term “and/or”, when used in a series of two or more elements, means that each of the items listed can either be used alone, or else any combination of two or more of the listed elements can be used. For example, if a combination is described which contains the components A, B and/or C, the combination can contain A alone; B alone; C alone; A and B in combination; A and C in combination; B and C in combination; or A, B, and C in combination.

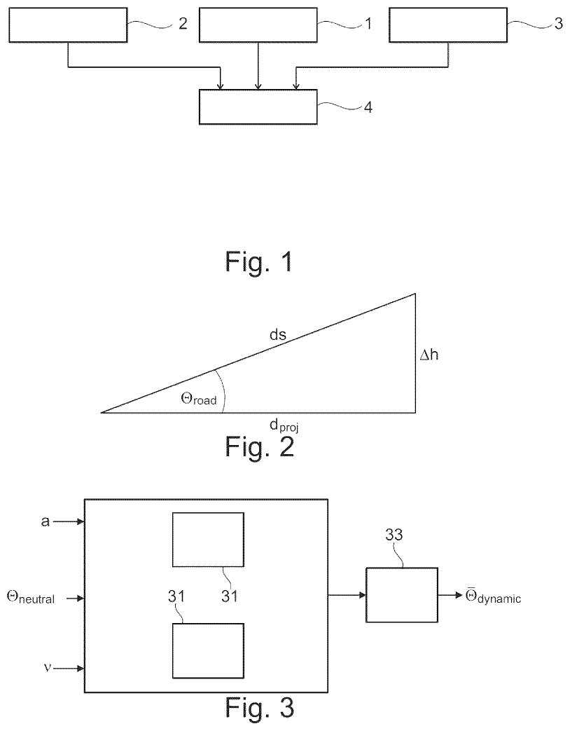

FIG. 1 shows a schematic diagram of a method according to examples disclosed herein for determining the current load pitch angle of a vehicle in the form of a flowchart. In operation 1, the speed, in particular the current speed, of the vehicle in the longitudinal direction is determined (e.g., detected or measured) and tracked using the device for determining the speed of the vehicle (e.g., the means for determining the speed of the vehicle). In operation 2, the longitudinal acceleration, in particular the current acceleration, of the vehicle is determined (e.g., detected or measured) and tracked using the device for determining the longitudinal acceleration (e.g., the means for determining the longitudinal acceleration) of the vehicle. In operation 3, the height change (e.g., the altitude change), in particular the current height change, of the vehicle is determined (e.g., detected or measured) and tracked using the device for determining the height change (e.g., the means for determining the height change) of the vehicle. The above-mentioned operations 1 through 3 can be executed simultaneously, for example.

In a fourth operation 4, while the vehicle is driving, the current load pitch angle is determined (e.g., estimated or calculated). The determination can be based on the speed of the vehicle in the longitudinal direction, longitudinal acceleration of the vehicle and height change of the vehicle, determined in a defined time interval or time window (e.g., in a definable or specified or specifiable time interval).

According to examples disclosed herein, the current load pitch angle θₙₑᵤₜᵣₐₗ is preferably determined using the following calculation:

$${Θ}_{neutral} \approx \frac{\int {a}_{meas} ds - \frac{1}{2} \cdot ( {v}_{2}^{2} - {v}_{1}^{2} ) - g \cdot Δ h + g \cdot {\overline{Θ}}_{dynamic} \cdot \sqrt{{s}^{2} - Δ {h}^{2}}}{- g \cdot \sqrt{{s}^{2} - Δ {h}^{2}} - g \cdot {\overline{Θ}}_{dynamic} \cdot Δ h} ,$$

where s is the distance traveled by the vehicle in an integration interval under consideration, v₁ is the speed of the vehicle at the beginning of the integration interval, v₂ is the speed of the vehicle at the end of the integration interval, Δh is the height difference covered by the vehicle during the integration interval, aₘₑₐₛ is the measured longitudinal acceleration of the vehicle, g is the gravitational constant and θ̅_{dynamic} is the mean, i.e. averaged, dynamic pitch angle of the vehicle during the integration interval.

In this context, FIG. 2 illustrates the geometric relationship between the distance traveled ds, the height difference Δh, the projection sₚᵣₒⱼ of ds on the horizontal plane and the angle of inclination of the road surface θ_{road}, which was used above to derive the above formula.

In the context of the method according to examples disclosed herein, the mean dynamic pitch angle can be determined based on a model. An example of this is shown in FIG. 3 in the form of a block diagram. The model can include two lookup tables 31 and 32. The model and/or the two lookup tables 31 and 32 may be tailored to a specific vehicle or vehicle model (e.g., a specific vehicle type). Of the two lookup tables 31, a first lookup table can be designed to determine a speed-based value of the dynamic pitch angle θ_{dynamic_a} as a function of the determined acceleration a, e.g. the current acceleration, of the vehicle and a selected load pitch angle θₙₑᵤₜᵣₐₗ, and a second lookup table can be designed to determine a speed-based value of the dynamic pitch angle θ_{dynamic_v} as a function of the determined speed v (e.g., the current speed) of the vehicle and a selected load pitch angle θₙₑᵤₜᵣₐₗ. The selected load pitch angle θₙₑᵤₜᵣₐₗ is a load pitch angle selected from a plurality of required or assumed load pitch angles, which was defined in advance for a specific loading situation. The mean dynamic pitch angle can be determined by averaging 33 from an acceleration-based value of the dynamic pitch angle θ_{dynamic_a} determined based on the first lookup table and a speed-based value of the dynamic pitch angle θ_{dynamic_v} determined based on the second lookup table.

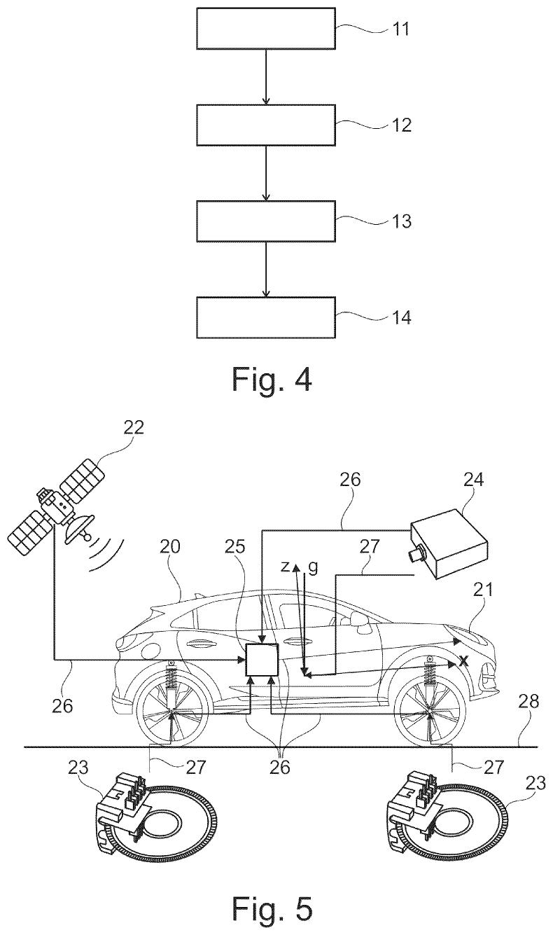

FIG. 4 is a schematic drawing of a method according to examples disclosed herein for beam height adjustment in the form of a flowchart. In operation 11, a setting position of the at least one headlamp for controlling the beam height is determined. The prerequisite for this is an adjustment of the zero angle. Thus, with a nominal basic setting of a stepper motor angle, the headlamp is calibrated as part of the assembly in such a way that a defined light exit gradient is achieved. This means that the headlamp is mechanically and/or optically adjusted (headlamp adjustment), for example. In doing so, a zero angle command can be issued to set the beam height, which this also then moves to. At the same time, the corresponding load pitch angle (reference load angle, zero load angle) can be determined (e.g., using the measured longitudinal vehicle acceleration).

In operation 12, the current load pitch angle of the vehicle is determined, in particular relative to the zero load angle or to the setting position determined in operation 11, for example by a method described above in connection with FIG. 1. In operation 13, based on the determined current load pitch angle of the vehicle, the deviation of the current load pitch angle from the setting position is determined and, thus, the resulting deviation of the headlamp from the setting position. In this context, a new setpoint angle can be defined. Then, in operation 14, the setting, in particular the light exit angle of the at least one headlamp, is adjusted according to the determined deviation (e.g., the defined, new target angle is activated).

Example instructions and/or operations of FIGS. 1 and 4 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 shows a schematic drawing of a motor vehicle 20 according to examples disclosed herein having an example device 25 for beam height adjustment. The road surface is designated by the reference sign 28. A vehicle-based coordinate system is indicated by way of the arrows x (longitudinal direction) and z. The direction of gravitation is indicated by an arrow g. The motor vehicle 20 comprises at least one headlamp 21, for example a front headlamp. Furthermore, the vehicle 20 or the device for beam height adjustment 25 comprises a device 23 for determining the speed (e.g., means for determining the speed) of the vehicle in the longitudinal direction, at least device 24 for determining the longitudinal acceleration (e.g., means for determining the longitudinal acceleration) of the vehicle and at least one device 22 for determining the height change (e.g., means for determining the height change) of the vehicle 20.

The device 23 for determining the speed of the vehicle in the longitudinal direction may be configured in the form of rotation speed sensors arranged on the wheels or wheel axles. The device 24 for determining the longitudinal acceleration of the vehicle may comprise a longitudinal acceleration sensor. The arrows 27 indicate the positions of the respective devices 24 and 23. The device 22 for determining the height device of the vehicle 20 may implemented as a GNSS sensor. Alternatively, the means 22 can be implemented as an ambient air pressure sensor or as a position sensor in combination with map data.

The beam height adjustment device 25 is configured to receive data from the device 23 for determining the speed of the vehicle, the device 24 for determining the longitudinal acceleration of the vehicle and the device 22 for determining the height change of the vehicle, and for carrying out a method according to examples disclosed herein for beam height adjustment, for example a method described with reference to FIG. 1. The data transmission is indicated in FIG. 5 by arrows with the reference sign 26. For setting, in particular for controlling or adjusting the beam height of the headlamp 21, the beam height adjustment device 25 transmits corresponding data to a control unit, for example for controlling a stepper motor within the headlamp 21.

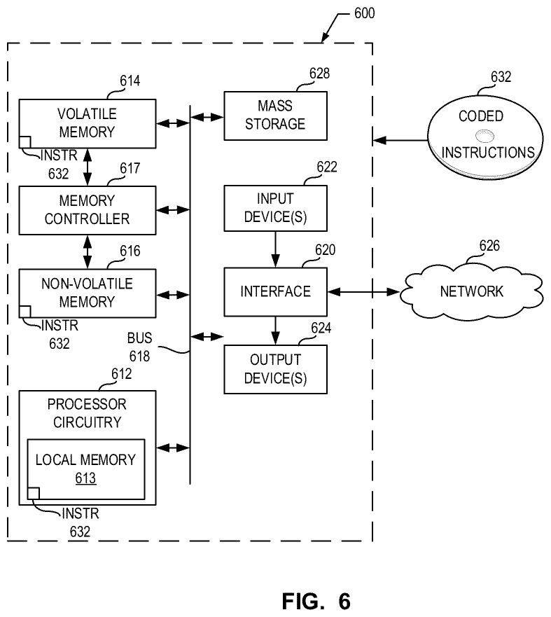

FIG. 6 is a block diagram of an example programmable circuitry platform 600 structured to execute and/or instantiate the example machine-readable instructions and/or the example operations of FIGS. 1 and 4 to implement examples disclosed herein. The programmable circuitry platform 600 can be, for example, a control device, an electronic control unit (ECU), a self-learning machine (e.g., a neural network), or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 612 may be implemented by one or more semiconductor based (e.g., silicon based) devices.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a button, a touchscreen, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 632, which may be implemented by the machine-readable instructions of FIGS. 1 and 4, may be stored in the mass storage device 628, in the volatile memory 614, in the non-volatile memory 616, and/or on at least one non-transitory computer readable storage medium such as a CD or DVD which may be removable.

Example methods, apparatus, systems, and articles of manufacture to enable accurate height adjustment of a headlamp are disclosed herein. Further examples and combinations thereof include the following:

Example 1 includes a method for determining a load pitch angle of a vehicle for adjustment of a headlamp, the vehicle including (i) a first sensor for measuring a speed of the vehicle, (ii) a second sensor for measuring an acceleration of the vehicle, and (iii) a third sensor for measuring a height change of the vehicle, the method comprising determining the speed of the vehicle based on first output from the first sensor during a time interval, determining the acceleration of the vehicle based on second output from the second sensor during the time interval, determining the height change of the vehicle based on third output from the third sensor during the time interval, determining the load pitch angle based on the speed, the acceleration and the height change corresponding to the time interval, and controlling the adjustment of the headlamp based on the determined load pitch angle.

Example 2 includes the method as defined in Claim 1, wherein the speed and the acceleration of the vehicle correspond to a longitudinal directional direction of the vehicle.

Example 3 includes the method as defined in Claim 1, wherein the load pitch angle is determined via a dynamic pitch model.

Example 4 includes the method as defined in Claim 1, wherein the third sensor includes at least one of a GNSS sensor, an ambient pressure sensor or a position sensor, and wherein the height change is determined based on map data.

Example 5 includes the method as defined in Claim 1, wherein the second sensor includes an acceleration sensor for determining the speed along a longitudinal direction of the vehicle.

Example 6 includes the method as defined in Claim 1, including determining a mean dynamic pitch angle corresponding to the time interval, wherein the load pitch angle is determined based on the mean dynamic pitch angle.

Example 7 includes the method as defined in Claim 6, wherein the mean dynamic pitch angle is determined based on a model corresponding to a type of the vehicle.

Example 8 includes the method as defined in Claim 7, wherein the model includes lookup tables, the lookup tables including a first lookup table that corresponds to an acceleration-based value of a dynamic pitch angle as a function of a measured acceleration of the vehicle and a selected load pitch angle, and a second lookup table that corresponds to a speed-based value of the dynamic pitch angle as a function of the measured speed of the vehicle and a selected load pitch angle.

Example 9 includes the method as defined in Claim 8, wherein the mean dynamic pitch angle is determined based on (i) averaging from an acceleration-based value of the dynamic pitch angle determined via the first lookup table, and (ii) a speed-based value of the dynamic pitch angle determined via the second lookup table.

Example 10 includes an apparatus to control beam adjustment for a headlamp of a vehicle, the apparatus comprising a first sensor for determining a speed of the vehicle, a second sensor for determining an acceleration of the vehicle, a third sensor for determining a height change of the vehicle, machine readable instructions, and programmable circuitry to determine a load pitch angle based on the speed, the acceleration and the height change, and cause adjustment of the headlamp based on the determined load pitch angle.

Example 11 includes the apparatus as defined in Claim 10, wherein the speed measured by the first sensor and the acceleration measured by the second sensor corresponds to a longitudinal directional direction of the vehicle.

Example 12 includes the apparatus as defined in Claim 10, wherein the programmable circuitry is to determine the load pitch angle via a dynamic pitch model.

Example 13 includes the apparatus as defined in Claim 10, wherein the third sensor includes at least one of a GNSS sensor, an ambient pressure sensor or a position sensor.

Example 14 includes the apparatus as defined in Claim 10, wherein the second sensor includes an acceleration sensor for determining the speed of the vehicle along a longitudinal direction of the vehicle.

Example 15 includes the apparatus as defined in Claim 10, including a stepper motor for adjustment of the headlamp based on determined load pitch angle.

Example 16 includes a non-transitory machine readable storage medium comprising instructions to cause programmable circuitry to at least: determine a speed of a vehicle during a time interval, determine an acceleration of the vehicle during the time interval, determine a height change of the vehicle during the time interval, determine a load pitch angle of the vehicle based on the speed, the acceleration and the height change, and control an adjustment of the headlamp based on the determined load pitch angle.

Example 17 includes the machine readable storage medium as defined in Claim 16, wherein the load pitch angle is determined via a dynamic pitch model.

Example 18 includes the machine readable storage medium as defined in Claim 16, wherein the instructions cause the programmable circuitry to determine a mean dynamic pitch angle corresponding to the time interval, and wherein the load pitch angle is determined based on the mean dynamic pitch angle.

Example 19 includes the machine readable storage medium as defined in Claim 18, wherein the mean dynamic pitch angle is determined based on lookup tables including a first lookup table corresponds to an acceleration-based value of the dynamic pitch angle as a function of a measured acceleration of the vehicle (and a selected load pitch angle and a second lookup table corresponds to a speed-based value of the dynamic pitch angle as a function of the measured speed of the vehicle (20) and a selected load pitch angle.

Example 20 includes the machine readable storage medium as defined in Claim 19, wherein the mean dynamic pitch angle is determined based on (i) averaging from an acceleration-based value of the dynamic pitch angle determined via the first lookup table, and (ii) a speed-based value of the dynamic pitch angle determined via the second lookup table.

What is claimed is:

1. A method for determining a load pitch angle of a vehicle for adjustment of a headlamp, the vehicle including: (i) a first sensor for measuring a speed of the vehicle, (ii) a second sensor for measuring an acceleration of the vehicle, and (iii) a third sensor for measuring a height change of the vehicle, the method comprising:
determining the speed of the vehicle based on first output from the first sensor during a time interval;
determining the acceleration of the vehicle based on second output from the second sensor during the time interval;
determining the height change of the vehicle based on third output from the third sensor during the time interval;
determining the load pitch angle based on the speed, the acceleration and the height change corresponding to the time interval; and
controlling the adjustment of the headlamp based on the determined load pitch angle.

2. The method as defined in claim 1, wherein the speed and the acceleration of the vehicle correspond to a longitudinal directional direction of the vehicle.

3. The method as defined in claim 1, wherein the load pitch angle is determined via a dynamic pitch model.

4. The method as defined in claim 1, wherein the third sensor includes at least one of a Global Navigation Satellite System (GNSS) sensor, an ambient pressure sensor or a position sensor, and wherein the height change is determined based on map data.

5. The method as defined in claim 1, wherein the second sensor includes an acceleration sensor for determining the speed along a longitudinal direction of the vehicle.

6. The method as defined in claim 1, including determining a mean dynamic pitch angle corresponding to the time interval, wherein the load pitch angle is determined based on the mean dynamic pitch angle.

7. The method as defined in claim 6, wherein the mean dynamic pitch angle is determined based on a model corresponding to a type of the vehicle.

8. The method as defined in claim 7, wherein the model includes lookup tables, the lookup tables including:
a first lookup table that corresponds to an acceleration-based value of a dynamic pitch angle as a function of a measured acceleration of the vehicle and a selected load pitch angle; and
a second lookup table that corresponds to a speed-based value of the dynamic pitch angle as a function of the measured speed of the vehicle and a selected load pitch angle.

9. The method as defined in claim 8, wherein the mean dynamic pitch angle is determined based on (i) averaging from an acceleration-based value of the dynamic pitch angle determined via the first lookup table, and (ii) a speed-based value of the dynamic pitch angle determined via the second lookup table.

10. An apparatus to control beam adjustment for a headlamp of a vehicle, the apparatus comprising:
a first sensor for determining a speed of the vehicle;
a second sensor for determining an acceleration of the vehicle;
a third sensor for determining a height change of the vehicle;
machine readable instructions; and
programmable circuitry to:
determine a load pitch angle based on the speed, the acceleration and the height change, and
cause adjustment of the headlamp based on the determined load pitch angle.

11. The apparatus as defined in claim 10, wherein the speed measured by the first sensor and the acceleration measured by the second sensor corresponds to a longitudinal directional direction of the vehicle.

12. The apparatus as defined in claim 10, wherein the programmable circuitry is to determine the load pitch angle via a dynamic pitch model.

13. The apparatus as defined in claim 10, wherein the third sensor includes at least one of a Global Navigation Satellite System (GNSS) sensor, an ambient pressure sensor or a position sensor.

14. The apparatus as defined in claim 10, wherein the second sensor includes an acceleration sensor for determining the speed of the vehicle along a longitudinal direction of the vehicle.

15. The apparatus as defined in claim 10, including a stepper motor for adjustment of the headlamp based on determined load pitch angle.

16. A non-transitory machine readable storage medium comprising instructions to cause programmable circuitry to at least:
determine a speed of a vehicle during a time interval;
determine an acceleration of the vehicle during the time interval;
determine a height change of the vehicle during the time interval;
determine a load pitch angle of the vehicle based on the speed, the acceleration and the height change; and
control an adjustment of a headlamp of the vehicle based on the determined load pitch angle.

17. The machine readable storage medium as defined in claim 16, wherein the load pitch angle is determined via a dynamic pitch model.

18. The machine readable storage medium as defined in claim 16, wherein the instructions cause the programmable circuitry to determine a mean dynamic pitch angle corresponding to the time interval, and wherein the load pitch angle is determined based on the mean dynamic pitch angle.

19. The machine readable storage medium as defined in claim 18, wherein the mean dynamic pitch angle is determined based on lookup tables including:
a first lookup table corresponds to an acceleration-based value of the dynamic pitch angle as a function of a measured acceleration of the vehicle and a selected load pitch angle; and
a second lookup table corresponds to a speed-based value of the dynamic pitch angle as a function of a measured speed of the vehicle and a selected load pitch angle.

20. The machine readable storage medium as defined in claim 19, wherein the mean dynamic pitch angle is determined based on (i) averaging from an acceleration-based value of the dynamic pitch angle determined via the first lookup table, and (ii) a speed-based value of the dynamic pitch angle determined via the second lookup table.
